(19) United States
(12) Patent Application Publication
(10) Pub. No.: US 2026/0206720 A1
(43) Pub. Date: Jul. 23, 2026

(54) ADJUSTABLE CUSHION PROTECTOR CAT TREE AND BED PLATFORM

(71) Applicants: Sharon Cooper, Torrance, CA (US); Harold Goldberg, Laguna Woods, CA (US)

(72) Inventors: Sharon Cooper, Torrance, CA (US); Harold Goldberg, Laguna Woods, CA (US)

(21) Appl. No.: 18/831,992

(22) Filed: Jan. 7, 2026

Related U.S. Application Data
(60) Provisional application No. 63/833,748, filed on Jan. 13, 2025.

(51) Int. Cl. A01K 1/035; A01K 15/02

(52) U.S. Cl. CPC A01K 1/0353; A01K 15/024

(57) ABSTRACT

The Adjustable Cushion Protector Cat Tree And Bed Platform invention is a cat tree that can be height-adjustable to be raised as much as needed to enable the attached cat bed platform to overhang the back cushions of a couch. The cat bed platform is adjustable so it can overhang the cushions at varying horizontal depths, thereby preventing a cat from damaging the couch cushions.

### FIELD OF THE INVENTION

This invention relates to cat trees with supports for cats to lay on.

### BACKGROUND OF INVENTION

Cats like to be next to their human companions who are sitting on a couch. They will therefore sit on top of the couch's back cushions. In those circumstances they can harm the couch in a number of ways: they can soil the couch cushions, leave cat fur on the cushions that is hard to remove even with vacuuming, scratch cushions, or crush the tops of the back cushions with their weight.

One solution has been to put a blanket or sheet on the couch, but this does not prevent a cat's claws from cutting through the blanket or sheet to the cushions or from crushing the cushions.

Another possible solution has been to place a scratching post with a tree and cat bed platform next to the couch. However, currently available scratching posts cannot prevent those problems since the cat bed platform has a fixed connection to the scratching post and cannot be height-adjusted to overhang the cushions of varying couch heights or be adjusted for varying horizontal depths of the cushions. Their floor base, which also has a fixed connection to the scratching post, cannot be adjusted to slide under the couch at varying horizontal depths for stability, or, if a couch is positioned next to a wall, to enable it to be placed in the small area between the back of the couch and the wall.

### SUMMARY OF THE INVENTION

Our invention is a novel way to solve the problems described above. It is comprised of adjustable vertical member or members, like a cat scratching post, that is attached to an adjustable horizontal support, like a cat bed platform, which overhangs the couch's back cushions, and an adjustable floor base. The invention allows the cat to lay on the horizontal support, which can include a cat bed, and be next to their human companion and not be in contact with the couch cushions, thereby protecting the cushions. In some embodiments, the invention includes a floor base that is attached to the vertical member(s) so that when the vertical member(s) is placed next to the back of the couch, the floor base can slide under the couch at varying horizontal depths depending on where the invention is placed in a room (either free standing or between the back of the couch and a wall).

The purpose of the invention is for the horizontal support to be height-adjustable so it can be raised or lowered on the vertical member(s). In this way the horizontal support is able to overhang the couch's back cushions depending on the height of the top of the couch's back cushions from the floor. When the invention is placed next to the back of a couch, the horizontal support can be adjusted to increase or decrease the overhang horizontal depth of the couch's back cushions according to the needs of the human companion. In this way the cat can sit or lay on the overhanging horizontal support and not be on the top of the couch's back cushions, thereby protecting the cushions from being damaged.

To accommodate different couch heights, the vertical member(s) with the attached horizontal support can be set at a chosen height and secured in place. The horizontal support can be connected to the vertical member in its center, or “off-center,” so it can adjust the amount it overhangs the couch cushions when the invention is placed next to the back of the couch. In a similar fashion, the vertical member(s) can be attached to the floor base either in the center or “off-center” of the floor base so the invention can be adjusted based on how far it needs to slide under the couch for stability or to accommodate placement between the back of the couch and a wall.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining embodiments of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

One object is to provide an adjustable cushion protector cat tree and bed platform for the purpose of the invention where the horizontal support of the adjustable cushion protector cat tree and bed platform is adjustable so it can be raised or lowered on a vertical member(s) (where the bottom of the vertical member(s) can be connected to a floor base either in its center or “off-center) at any chosen height and secured in place, and where the horizontal support can be connected in its center or “off-center” on the top of the vertical member(s) so it can overhang a couch when the vertical member(s) is placed next to the couch.

Another object is to provide an adjustable cushion protector cat tree and bed platform that has a horizontal support attached to a vertical member(s), which is connected to a floor base, and where the adjustable cushion protector cat tree and bed platform is made of a hollow telescoping vertical member(s) that can slide up and down inside another vertical member(s) so that the height of the adjustable cushion protector cat tree and bed platform can be adjustable, and where the telescoping vertical member(s) have holes drilled through them and can be locked in place by a screw (or other methods suitable for locking) that is inserted through the holes when the chosen height is set.

Another object is to provide an adjustable cushion protector cat tree and bed platform where the hollow telescoping vertical member(s) that can slide up and down inside another vertical member(s), as in the object described above, have one or more solid objects, like disks, that are placed between the bottom of the inside vertical member(s) and the top of the floor base in a way that keeps the inside vertical member(s) secured from moving downward once the chosen height is set.

Another object is to provide an adjustable cushion protector cat tree and bed platform that has a horizontal support that can be attached in its center or “off-center” position on the vertical member(s) so that the amount of its overhanging over a couch, or some other piece of furniture or object, can be adjusted when the adjustable cushion protector cat tree and bed platform is placed next to the couch or other object.

Another object is to provide an adjustable cushion protector cat tree and bed platform that has a vertical member(s) that can be attached to a floor base in the center of the floor base or “off-center”, allowing the floor base to slide under a couch at varying depths when the adjustable cushion protector cat tree and bed platform is placed next to a couch.

Another object is to provide an adjustable cushion protector cat tree and bed platform that has a vertical member(s) that can have a plain surface or be covered with carpeting, fabric or sisal or any other material.

Another object is to provide an adjustable cushion protector cat tree and bed platform that has a horizontal support where its bottom side is connected with an L-bracket (or other connecting device) to a vertical member(s) which has holes for screws drilled through it at various levels so the horizontal support can be connected at various heights so as to allow the horizontal support to be raised or lowered at any chosen height and locked in place.

Another object is to provide an adjustable cushion protector cat tree and bed platform where a vertical member(s) (connected to a floor base) is placed next to the back of a couch, and has a shelf is attached to it that presses against the underside of the couch for stability.

Another object is to provide an adjustable cushion protector cat tree and bed platform where two or more vertical members are attached to a shelf that connects them together for stability.

Another object is to provide an adjustable cushion protector cat tree and bed platform that has vertical members which are attached to a horizontal support which fits over the back of a couch like a saw horse, and where the height of the horizontal support can be adjusted with inserts that are placed between underneath the horizontal support and the top of the back of the couch.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

Example embodiments will become more fully understood from the detailed descriptions given herein below and the accompanying drawings, wherein like elements are represented by like reference characters, which are given by way of illustration only and thus are not limitative of the example embodiments herein.

### BRIEF DESCRIPTION OF THE DRAWINGS

FIG. 1 is a perspective view of the preferred embodiment, the “Double Vertical Members” embodiment.

FIG. 2 is a perspective view of the preferred embodiment showing the invention next to a couch.

FIG. 3 is a perspective view of the preferred embodiment showing the invention between a couch and a wall.

FIG. 4 is a side view of the “L-Bracket” embodiment.

FIG. 5 is a perspective view of the “L-Bracket” embodiment.

FIG. 6 is a side view of the “Telescope with locking screw” embodiment.

FIG. 7 is a side view of the “Telescope with disks” embodiment.

FIG. 8 is a side view of the “Threaded Cylinders” embodiment.

FIG. 9 is a perspective view of the “Threaded Cylinders” embodiment next to a couch.

FIG. 10 is a perspective view of the “Saw Horse” embodiment.

FIG. 11 is a side view of the “Saw Horse” embodiment.

FIG. 12 is a side view of the “Saw Horse” embodiment on a couch back.

### DETAILED DESCRIPTION

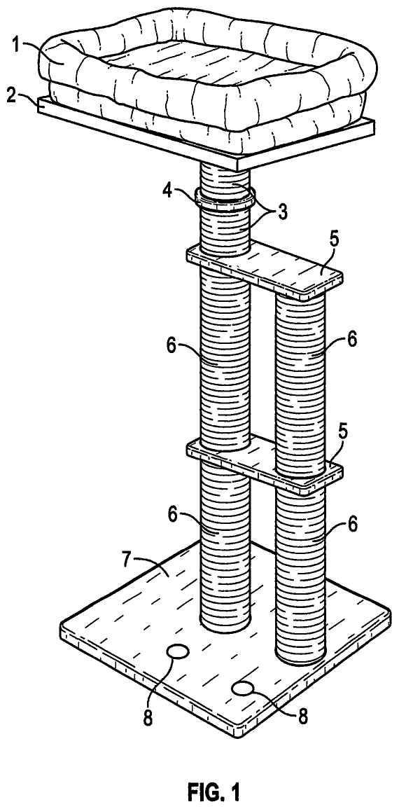

The preferred embodiment of the invention, the “Double Vertical Members” embodiment, is illustrated in FIG. 1. (This embodiment was publicly disclosed starting Jan. 15, 2025, within the 12 month grace period on Amazon: Amazon ASIN B0FVVPDD5). At the top of the invention is a cat bed 1 which can be made of any soft material suitable for the comfort of a cat. It is attached to the top of a horizontal support 2. The structure of the horizontal support 2 can be made of a solid material, like wood or MDF. Preferably its composition and dimensions should be adequate to support cats of various sizes and weights. An example dimension would be 15 inches by 12 inches and ¼ inch thick.

The horizontal support 2 is attached to a small vertical member section 3. It can be attached in various commonly known methods. The purpose of the horizontal support 2 is to be adjustable so it can overhang the couch's back cushions. To accomplish this purpose the horizontal support 2 can be attached on to the small vertical member section in various places so that it can be adjusted to overhang the couch's back cushions at varying horizontal depths. Currently available cat scratching posts cannot be adjusted in that manner.

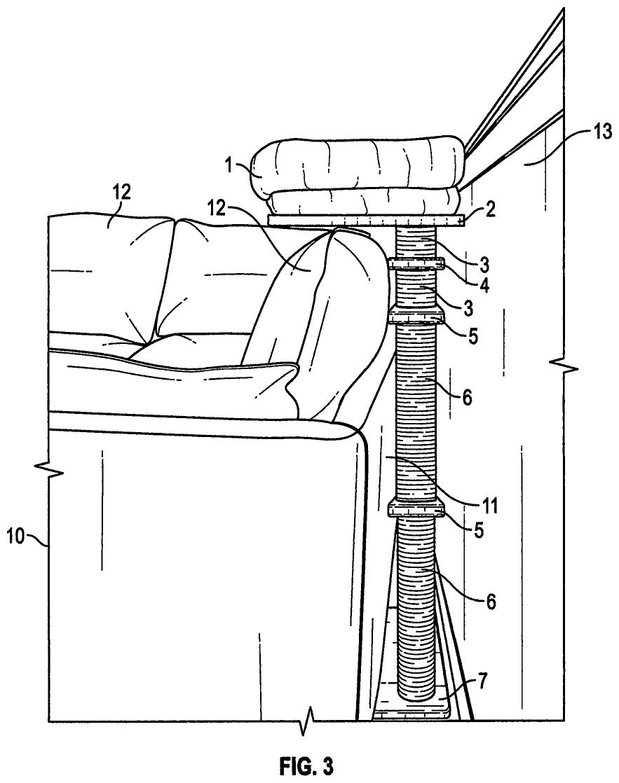

The structure of the small vertical member section 3 is a typical hollow scratching post constructed of a kraft paper tube or other sturdy material. In FIG. 3 it is covered with sisal rope and its dimensions are 3 inches in diameter and 3 inches in length. There are 2 small vertical member sections 3 shown on the drawing and in between them is spacer 4. The spacer 4 is made of a solid material like wood or plastic, or any other sturdy material that can bear the weight of the invention and a cat. The spacer 4 is covered with a textile material and measures 3 inches in diameter and ½ inch thick.

The purpose of the small vertical member sections 3 and the spacer 4 is to enable the height of the horizontal support 2 to be adjusted to a height needed to overhang the couch's back cushions. More or fewer small vertical member sections 3 and spacers 4 can be utilized to achieve that height. Currently available cat scratching posts are not able to be adjusted for that purpose.

The lower small vertical member section 3 is attached to a connector shelf 5. It can be attached in various commonly known methods. The function of attaching the connector shelf 5 to two large vertical members 6 is to provide an improved way to stabilize the invention compared to existing scratching posts, in general. It is made of a sturdy material like wood or MDF. It is covered with a textile material and measures 4 inches by 10 inches and is ½ inch thick.

The connector shelf 5 is attached to large vertical members 6 which in turn are attached to another connector shelf 5 which in turn is attached to additional large vertical members 6. These components can be attached in various commonly known methods. The structure of the large vertical member 6 is the same as the small vertical member section 3 and measures 3 inches in diameter and 13 inches in length. They are covered in sisal rope. It can be attached in various commonly known methods. As with the small vertical member sections 3, more or fewer of the large vertical members 6 and connector shelves 5 can be utilized to achieve a height that enables the horizontal support 2 to be adjusted to overhang the couch's back cushions.

The lower large vertical members 6 are attached to the floor base 7. They can be attached in various commonly known methods. The structure of the floor base 7 is made of a solid material, such as wood or MDF. The floor base 7 measures 18 inches by 18 inches and is ½ inch thick. The floor base 7 can be covered with suitable textile material. The function of the floor base 7 is to serve as the support for the invention so that it will not tip over. Another function of the floor base 7 is to slide under the couch so that the large vertical members 6 and the small vertical members 3 can be placed next to the back of the couch. The floor base 7 also has additional holes 8 where the lower large vertical members can be attached. The purpose of attaching the lower large vertical members to holes 8 is to allow the floor base 7 to adjust how far it can slide under the couch for stability.

Additionally, by attaching the lower large vertical members 6 to holes 8 it enables the invention to be placed in the area between the back of the couch and a wall so that the floor base 7 can slide further underneath the couch and not protrude from the back of the couch where space is not permitting. Currently available cat scratching posts are attached to their floor bases only in the center, and therefore cannot be placed in the narrow area between the back of the couch and the wall.

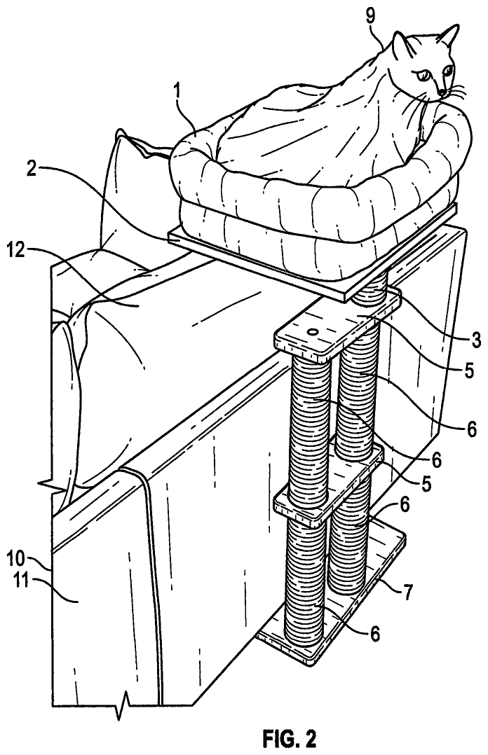

FIG. 2 shows the same embodiment as FIG. 1, the “Double Vertical Members” embodiment, with the cat bed 1, the horizontal support 2, the small vertical member section 3, the connector shelves 5, the large vertical members 6, and the floor base 7 the same as in the FIG. 1 drawings and descriptions above. Here in FIG. 2 the large vertical members 6 are attached to the floor base 7 near the edge of the floor base 7, illustrating the floor base 7 sliding under the couch 10. The invention is also shown placed next to the back of couch 11. The FIG. 2 drawing also shows the horizontal support 2 overhanging the back cushion 12, and shows a cat 9 laying on cat bed 1.

FIG. 3 shows the same embodiment as FIG. 1, the “Double Vertical Members” embodiment, with the cat bed 1, the horizontal support 2, the small vertical member section 3, the spacer 4, the connector shelves 5, the large vertical members 6, and the floor base 7 the same as in the FIG. 1 drawings and descriptions above. Here in FIG. 3 the invention is shown placed between the back of couch 11 and the wall 13, a narrow space that it can fit into when floor base 7 slides under couch 10. FIG. 3 also shows horizontal support 3 overhanging cushion 12.

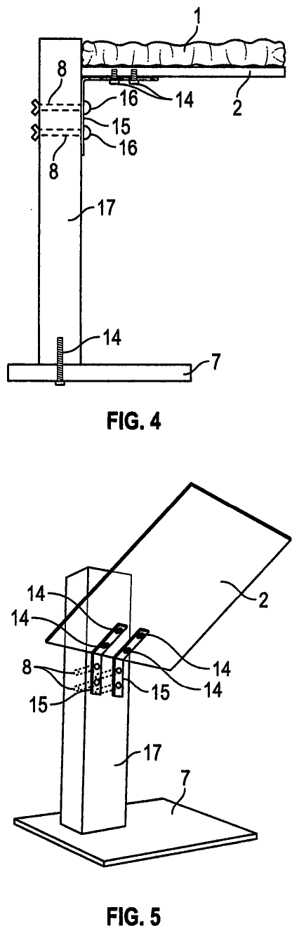

FIG. 4 shows a side view of the “L-Bracket” embodiment. At the top of the invention is the cat bed 1 which is attached to the horizontal support 2, as in FIG. 1. The horizontal support 2 is attached to a vertical member square post 17. The vertical member square post 17 is made of a sturdy material like wood or MDF. Its measurement is 45 inches by 5 inches by 5 inches, which allows it to be as tall as the majority of couch backs so that the horizontal support 2 can overhang the couch's back cushions. As in FIG. 1, this embodiment would be placed next the back of the couch.

The horizontal support 2 is attached to the vertical member square post 17 using one “leg” of the L-bracket 15 that is attached to the underside of the horizontal support 2 using screws 14. The other “leg” of the L-bracket 15 is attached to vertical member square post 17 with wing nut screws 16 that are threaded through the L-bracket 15 and hole 8 that is drilled through the vertical member square post 17.

Vertical member square post 17 can have holes 8 for the L-bracket 15 drilled at various height levels, thereby enabling the height of the horizontal support 2 to be lowered or raised to adjust the height needed to overhang the couch's back cushions. FIG. 4 shows the vertical member square post 17 attached to the floor base 7 with screw 14. Vertical member square post 17 could also be covered with sisal rope or other typical scratching post material.

FIG. 5 shows a perspective view of the “L-Bracket” embodiment, with the horizontal support 2, the vertical member square post 17, and the floor base 7 the same as in FIG. 4 drawings and descriptions above. The difference in FIG. 5 is that it shows there are two L-brackets 15, 2 sets of screws 14 and 2 sets of holes 8. The illustration also shows the horizontal support 2 attached at a lower level on the vertical member square post indicating that it is height-adjustable for varying couch back heights.

The L-brackets 15 can be made of any sturdy material that will not bend from the weight of the horizontal support 2, the cat bed 1, and cat itself. This could be metal or plastic, wood or any other strong material. The material of the screws 14 connecting the L-brackets 15 to the horizontal support 2 could be metal or other similar material. The material of the wing nut screws 16 connecting the L-brackets 15 to the vertical member square post 17 could be metal or other similar material.

Instead of L-brackets 15, the horizontal support 2 could be attached to the vertical member square post 17 by any other secure connecting device such as screws that are inserted directly through the vertical member square post 17 and into the horizontal support 2.

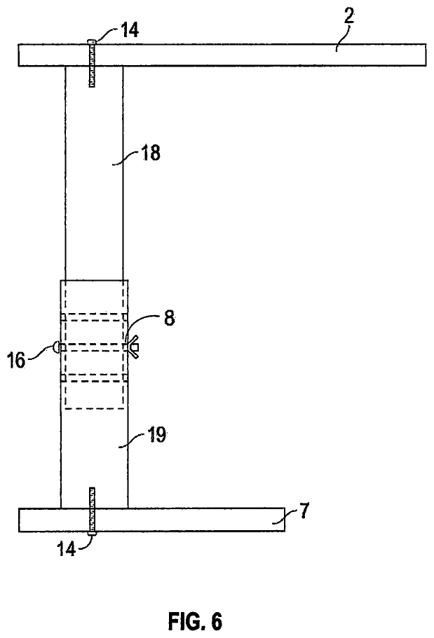

FIG. 6 shows a side view of the “Telescope with locking screw” embodiment. At the top of the invention is a horizontal support 2. The horizontal support 2 is attached to a vertical member inside telescope 18 with screw 14. The vertical member inside telescope 18 is hollow and is a cylinder and is made of a kraft paper tube or other sturdy material, similar to typical scratching posts. The vertical member inside telescope 18 is inserted into vertical member outside telescope 19 which is constructed similar to vertical member inside telescope 18. Vertical member outside telescope 19 is attached to floor base 7 with screw 14. Vertical member inside telescope 18 and vertical member outside telescope 19 will have lengths that when inserted together will have a combined length between 24 inches and 44 inches. Vertical member inside telescope 18 is 3 inches in diameter, and vertical member outside telescope 19 has a slightly larger diameter so as to allow vertical member inside telescope 18 to be able to slide up and down inside it like a telescope. Vertical member inside telescope 18 and vertical member outside telescope 19 have a hole 8 drilled through their walls so that a wing nut screw 16 can be inserted to secure them at the chosen position. The position chosen will enable the horizontal support 2 to be adjusted to overhang the couch's back cushions. Vertical member inside telescope 18 and vertical member outside telescope 19 have additional holes 8 drilled through their walls so that the wing nut screw 16 can be inserted to secure them at the additional chosen positions, if needed to adjust the height of the invention. The horizontal support 2 can also be adjusted to overhang the cushions at various horizontal depths over the cushions, as explained in the preferred embodiment. Vertical member inside telescope 18 could alternatively be a solid structure rather than hollow. Vertical member inside telescope 18 and vertical member outside telescope 19 could also be covered with sisal rope or other typical scratching post material. As in the preferred embodiment, this embodiment would be placed next to the back of the couch.

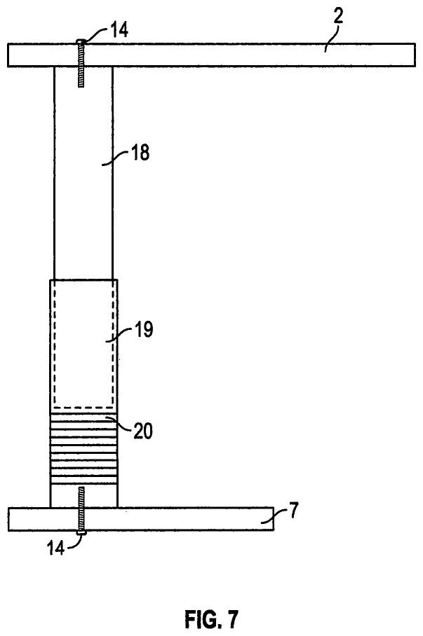

FIG. 7 shows a side view of the “Telescope with disks” embodiment with the horizontal support 2, the screws 14, the vertical member inside telescope 18, the vertical member outside telescope 19 and floor base 7 the same as in FIG. 6 drawings and descriptions above, except that the vertical member inside telescope 18 and the vertical member outside telescope 19 will not have drilled holes. The other difference in this embodiment is that it uses disks 20 which are placed between the bottom of vertical member inside telescope 18 and the top of floor base 7 to secure the position of the vertical member inside telescope 18 and the vertical member outside telescope 19 and thereby adjust the height of the invention. Note that In FIG. 7 the arrow points to only one of the disks 20 but additional disks 20 are also illustrated to indicate that more than one disk 20 could be used to adjust the height of the invention. Disks 20 will be made of a sturdy material and have a diameter that allow them to fit inside vertical member outside telescope 19, and will be ½ inch thick. Vertical member inside telescope 18 and vertical member outside telescope 19 could also be covered with sisal rope or other typical scratching post material. As in the preferred embodiment, this embodiment would be placed next to the back of the couch.

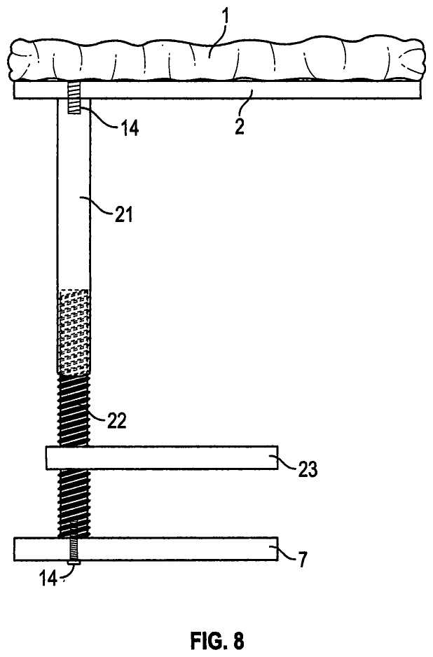

FIG. 8 shows a side view of the “Threaded Cylinders” embodiment. The illustration shows the cat bed 1 on top of the horizontal support 2 as in the preferred embodiment. It shows the horizontal support 2 attached to the vertical member internal threading 21 using screw 14. Vertical member internal threading 21 has a 3 inch diameter. It is screwed onto vertical member external threading 22 which is attached to the floor base 7 with screw 14. A shelf 23 that has a hole with internal threading is screwed on to vertical member external threading 22. Vertical member internal threading 21 and vertical member external threading 22 will have lengths that when screwed together will have a combined length between 24 inches and 44 inches, and can be made of plastic or any sturdy material. The shelf 23 is 5 inches by 10 inches and is ½ inch thick and can be made of woods, MDF, or any sturdy material.

When vertical member inside threading 21 is screwed on the threading of vertical member external threading 22 it can be raised or lowered to enable the attached horizontal support 2 to overhang the couch's back cushions. As with the preferred embodiment, the horizontal support 2 can be adjusted to overhang the couch's back cushions at varying horizontal depths.

When the invention is placed next to the back of the couch, and shelf 23 is screwed on the threading of vertical member external threading 22, shelf 23 can be screwed on vertical member external threading 22 in a way that puts it in contact with the bottom underside of the back of the couch, thereby increasing the stability of the invention.

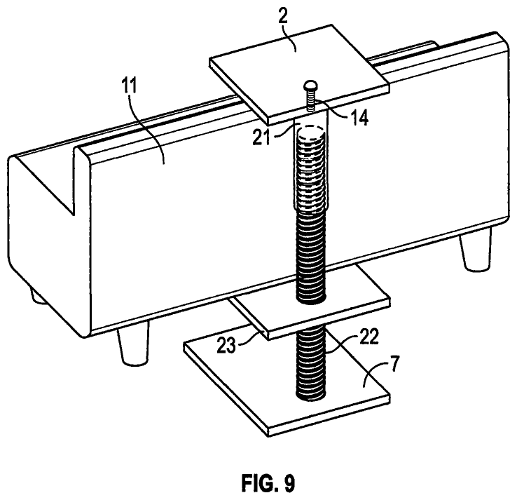

FIG. 9 is a perspective view of the “Threaded Cylinders” embodiment with the horizontal support 2, the screw 14, the vertical member internal threading 21, the vertical member external threading 22, the shelf 23 and the floor base 7 the same as in FIG. 8 and the description above. The difference from FIG. 8 is the addition of back of couch 11.

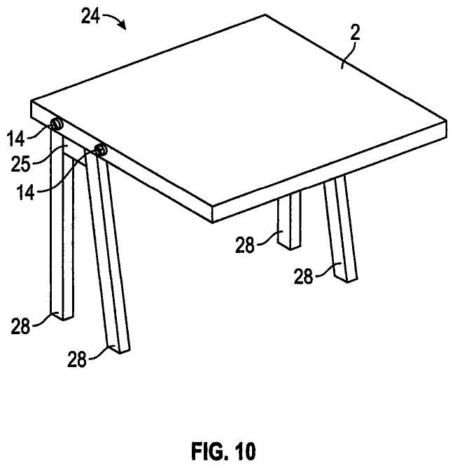

FIG. 10 is a perspective view of the “Saw Horse” embodiment. The saw horse shape 24 is comprised of a horizontal support 2, vertical member legs 28, screws 14 to attach vertical member legs 28 to horizontal support 2, and insert 25 to adjust the height of the invention to overhang the couch's back cushions. The vertical member legs 28 are made of wood, MDF or any sturdy material and measure 15 inches by ½ inch by 3 inches. The insert 25 measures 3 inches by 3 inches by ½ inch thick and can be made of wood, MDF or any sturdy material. The operation of the saw horse shape 24 is to straddle the couch back with 2 vertical member legs 28 in contact with the back the couch and 2 vertical member legs 28 between the back of the couch and the back cushions. In this position the horizontal support 2 will rest on the top of the back of the couch in order to overhang the couch's back cushions. If needed, one or more insert 25 can be placed between the underside of horizontal 2 and the top of the back of the couch to adjust the height of the horizontal support 2 and enable it to overhang the couch's back cushions. Horizontal support 2 can also be adjusted to increase the horizontal depth of overhanging the couch's back cushions, as with the preferred embodiment.

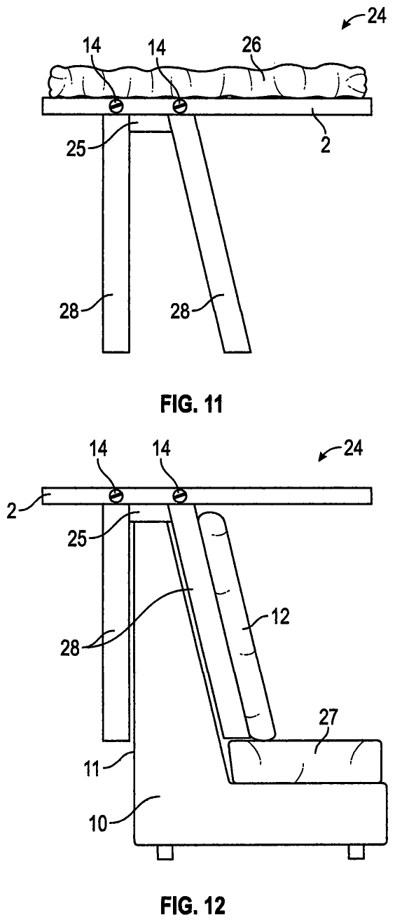

FIG. 11 is a side view of the “Saw Horse” embodiment with the saw horse shape 24, the horizontal support 2, the screws 14, the vertical member legs 28, and the insert 25 the same as in FIG. 10 and the description above. The difference is the addition of textile material 26 which can be made of any material for the comfort of a cat to lay on.

FIG. 12 is a side view of the “Saw Horse” embodiment with the saw horse shape 24, the horizontal support 2, the screws 14, the vertical member legs 28, and the insert 25 the same as in FIG. 10. The differences are showing invention straddling the back of couch 11, the couch 10, the back cushion 12, and the seat cushion 27. In this illustration the horizontal support 2 is overhanging the back cushion 12.

Unless otherwise defined, all technical and scientific terms used herein have the same meaning as commonly understood by one of ordinary skill in the art to which this invention belongs. Although methods and materials similar to or equivalent to those described herein can be used in the practice or testing of the adjustable cushion protector cat tree and bed platform, suitable methods and materials are described above. All publications, patent applications, patents, and other references mentioned herein are incorporated by reference in their entirety to the extent allowed by applicable law and regulations. The adjustable cushion protector cat tree and bed platform may be embodied in other specific forms without departing from the spirit or essential attributes thereof, and it is therefore desired that the present embodiments be considered in all respects as illustrative and not restrictive.

The invention claimed is:

1. A vertical member, or members, a floor base, and a horizontal support for use to overhang and protect a couch's back cushions, comprising:
a vertical member, or members, that can be attached to a floor base at various places and can be adjusted to extend upward from said horizontal floor base to at least the height of the top of the couch's back cushions;
a floor base wherein said floor base can be adjusted to be placed under the couch at various depths;
a horizontal support that is attached to said vertical member, or members, and wherein said horizontal support can be attached at various places on said vertical member, or members, to adjust its height from the floor and can be adjusted to overhang the couch's back cushions at various horizontal depths.

2. A vertical member, or members, a floor base, and horizontal support for use to overhang and protect a couch's back cushions as in claim 1, wherein said horizontal floor base has a varying number of holes for screws to attach it to said vertical member, or members, so as to allow said floor base to be placed under said couch at various depths under said couch when said vertical member, or members, is placed next to said couch.

3. A vertical member, or members, a floor base, and horizontal support for use to overhang and protect a couch's back cushions as in claim 1, wherein said vertical member, or vertical members, is attached to one or more vertical member sections to increase the height of said vertical member, or members, above the top of said couch's back cushions.

4. A vertical member, or members, a floor base, and horizontal support for use to overhang and protect a couch's back cushions as in claim 1, wherein said horizontal support has a varying number of holes for screws to attach it to said vertical member, or members, so as to allow said horizontal support to overhang the couch's back cushions at various horizontal depths.

5. A vertical member, or members, a floor base, and horizontal support for use to overhang and protect a couch's back cushions as in claim 1, wherein said vertical member, or members, has a varying number of holes for screws to attach said horizontal support to said vertical member, or members at various heights

6. A vertical member, or members, a floor base, and horizontal support for use to overhang and protect a couch's back cushions as in claim 1, wherein said horizontal support is covered with, or made with, a textile or other material.

7. A vertical member, or members, a floor base, and horizontal support for use to overhang and protect a couch's back cushions as in claim 1, wherein said horizontal support is covered with a fabric cat bed.

8. A vertical member, or members, a floor base, and horizontal support for use to overhang and protect a couch's back cushions as in claim 1, wherein one of said vertical members is inserted into a second vertical member, like a telescope, and can be raised or lowered with the attached said horizontal support, and where its height can be fixed with a screw or other securing device.

9. A vertical member, or members, a floor base, and horizontal support for use to overhang and protect a couch's back cushions as in claim 1, wherein one of said vertical members is inserted into a second vertical member, like a telescope, and can be raised or lowered with the attached said horizontal support, and where its height is fixed with one or more disks which are stacked between the bottom of said inserted vertical member and the top of said floor base.

10. A vertical member, or members, a floor base, and horizontal support for use to overhang and protect a couch's back cushions as in claim 1, wherein one of said vertical members has external threading and is screwed into another vertical member that has internal threading, and where said vertical member with internal threading can be raised or lowered with the attached said horizontal support by turning it.

11. A vertical member, or members, a floor base, and horizontal support for use to overhang and protect a couch's back cushions as in claim 1, wherein a shelf is attached to a vertical member so that the shelf can slide under the back of a couch for stability of the invention.

12. A vertical member, or members, a floor base, and horizontal support for use to overhang and protect a couch's back cushions as in claim 1, wherein two or more vertical members are attached to a shelf for stability of the invention.

13. A saw-horse shape device for use to overhang and protect a couch's back cushions comprising vertical members, and a horizontal support where the vertical members are attached at one end of a horizontal support at angles to form a saw horse, and that allow the saw horse to be placed over the back of the couch so that the vertical members straddle the back of the couch and enable the horizontal support to rest on the top of the back of the couch and overhang the couch's back cushions.

14. A horizontal support as in claim 13 that can be attached to said vertical members in various places, so as to allow said horizontal support to overhang the couch's back cushions at various horizontal depths.

15. A horizontal support as in claim 13 that has inserts attached to its under-side so as to enable said horizontal support to be adjusted to raise its height above the top of the couch's back cushions.
